(19) United States
(12) Patent Application Publication
(10) Pub. No.: US 2026/0264099 A1
(43) Pub. Date: Sep. 10, 2026

(54) DEVICE AND SYSTEM FOR DISPENSING A LIQUID

(71) Applicant: Dispensing Technologies B.V., Eindhoven (NL)

(72) Inventors: Paulo NERVO, Eindhoven (NL); Petrus Lambertus Wilhelmus HURKMANS, EINDHOVEN (NL)

(73) Assignee: Dispensing Technologies B.V., Eindhoven (NL)

(21) Appl. No.: 19/167,030

(22) PCT Filed: Mar. 21, 2024
(86) PCT No.: PCT/NL2024/050145

§ 371 Date: Sep. 19, 2025

(30) Foreign Application Priority Data
Mar. 21, 2023 (NL) 2034393

(51) Int. Cl. B05B 11/10

(52) U.S. Cl. CPC B05B 11/1014

(57) ABSTRACT

A device for dispensing a liquid from a container comprising an inlet channel in fluid communication with the container and a pump in fluid communication with the inlet channel, the pump including a pump chamber and a piston reciprocally movable in the pump chamber. The liquid dispensing device further comprises a gas buffer in fluid communication with the pump, the gas buffer comprising a buffer chamber and a gas-filled compressible buffer bag arranged in the buffer chamber, a nozzle for dispensing the liquid, the nozzle in fluid communication with the pump and/or the gas buffer, and a pre-compression valve arranged between the pump and/or gas buffer and the nozzle. The pump chamber has an axis defining a direction of reciprocal movement of the piston which is arranged at an angle with respect to an axis of the inlet channel.

The invention relates to a device for dispensing a liquid from a container as a spray or as a foam. In particular, the invention relates to a liquid dispensing device which allows a liquid to be dispensed at a precisely controlled output pressure, and thus allows droplet sizes to be maintained within a narrowly defined range.

WO 2015/128446A 1 discloses a liquid dispensing device comprising: a piston chamber; a piston that is moveable within the piston chamber to pressurize a liquid to be dispensed; a nozzle with a defined throughput for dispensing the liquid; an outlet valve having a defined minimum opening pressure arranged between the piston chamber and the nozzle; and a buffer arranged between the piston chamber and the outlet valve. This type of liquid dispensing device, which is referred to as a buffering pre-compression sprayer, is configured to be mounted on a neck of a container for the liquid to be dispensed. In one example of the prior art dispensing device, the buffer is a gas buffer which is arranged in a slider carrying the piston, while in another example the buffer is a gas buffer which extends into the neck of the container.

The invention has for its object to provide a liquid dispensing device of the type discussed above which is structurally simple, which is relatively easy to assemble, and which may be manufactured at relatively low cost.

In accordance with the invention, this is achieved by a device for dispensing a liquid from a container which comprises an inlet channel configured to be brought in fluid communication with the container, a pump in fluid communication with the inlet channel, the pump including a pump chamber and a piston reciprocally movable in the pump chamber, and a gas buffer in fluid communication with the pump, the gas buffer comprising a buffer chamber and a gas-filled compressible buffer bag arranged in the buffer chamber. The liquid dispensing device of the invention further comprises a nozzle for dispensing the liquid, the nozzle in fluid communication with the pump and/or the gas buffer, and a pre-compression valve arranged between the pump and/or gas buffer and the nozzle. In this liquid dispensing device, the pump chamber has an axis defining a direction of reciprocal movement of the piston which is arranged at an angle with respect to an axis of the inlet channel.

In an embodiment of the liquid dispensing device, the axis of the pump chamber may be substantially perpendicular to the axis of the inlet channel.

In a further embodiment, the gas buffer may have an axis which is arranged at an angle with respect to the axis of the pump chamber.

In one embodiment, the axis of the gas buffer may be substantially perpendicular to the axis of the pump chamber. In that case, the gas buffer may be configured to extend into a neck of the container.

In another embodiment, the axis of the gas buffer may be arranged at an acute or obtuse angle with respect to the axis of the pump chamber.

In a further embodiment, an actuator may be operatively coupled to the piston and the gas buffer may be arranged at a side of the pump chamber opposite the actuator.

In yet another embodiment, the gas buffer may have an axis which is arranged substantially parallel to the axis of the pump chamber. In that case, the gas buffer may extend along an outlet channel which constitutes the fluid communication between the nozzle and the pump and/or the gas buffer.

In an embodiment of the liquid dispensing device, the buffer chamber may include at least one opening for establishing the fluid communication with the pump and with the nozzle, and the at least one opening may be arranged in a part of the buffer chamber facing the pump.

In an alternative embodiment of the liquid dispensing device, the buffer chamber may include an inlet opening for establishing the fluid communication with the pump and an outlet opening for establishing the fluid communication with the nozzle. In that case, the buffer chamber may have a sidewall substantially surrounding the buffer bag and opposite end walls, and at least one of the inlet opening and the outlet opening may be arranged in the sidewall.

In an embodiment, the liquid dispensing device may further comprise a pump outlet valve for interrupting the fluid communication between the gas buffer and the pump.

The invention further relates to a system for dispensing a liquid which comprises a container and a liquid dispensing device as defined above connected thereto.

The invention will now be elucidated by way of a number of exemplary embodiments, with reference being made to the annexed drawings, in which like elements are identified by reference numerals increased by “100”, and in which:

FIG. 1 is a side view of a system for dispensing a liquid which comprises a container and a first embodiment of a liquid dispensing device connected thereto;

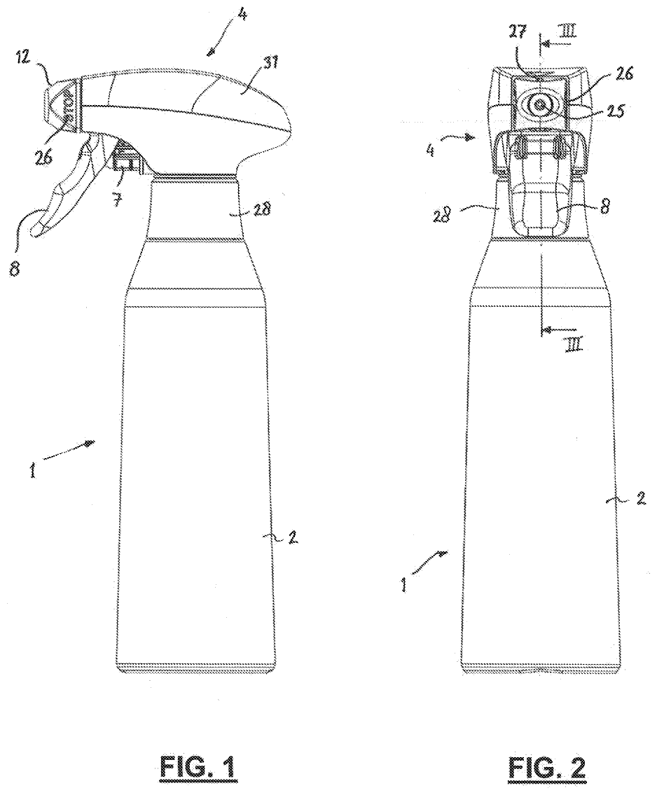

FIG. 2 is a front view of the system of FIG. 1;

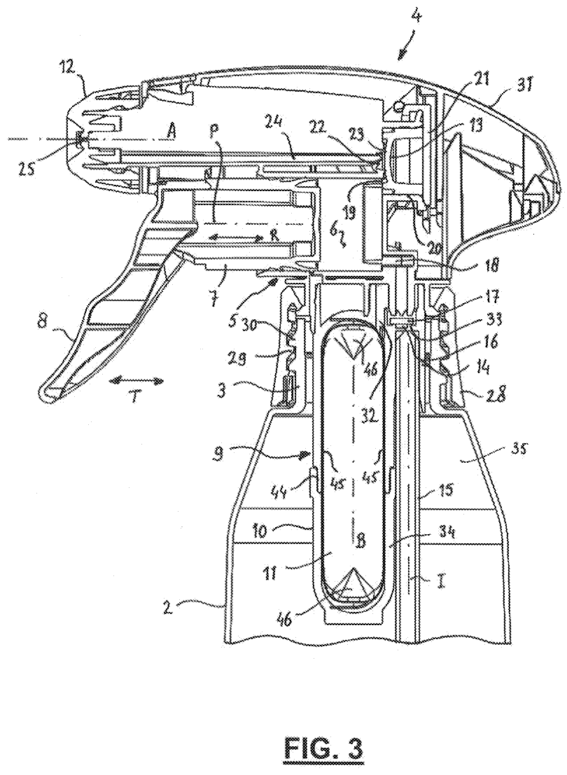

FIG. 3 is an enlarged scale cross-sectional view along the lines III-III in FIG. 2;

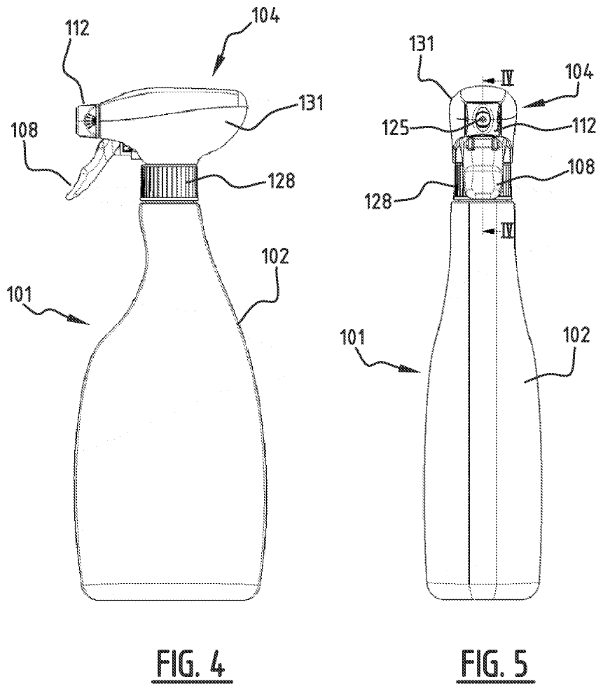

FIG. 4 is a side view of an alternative system for dispensing a liquid, comprising a different container and a second embodiment of the liquid dispensing device;

FIG. 5 is a front view of the system of FIG. 4;

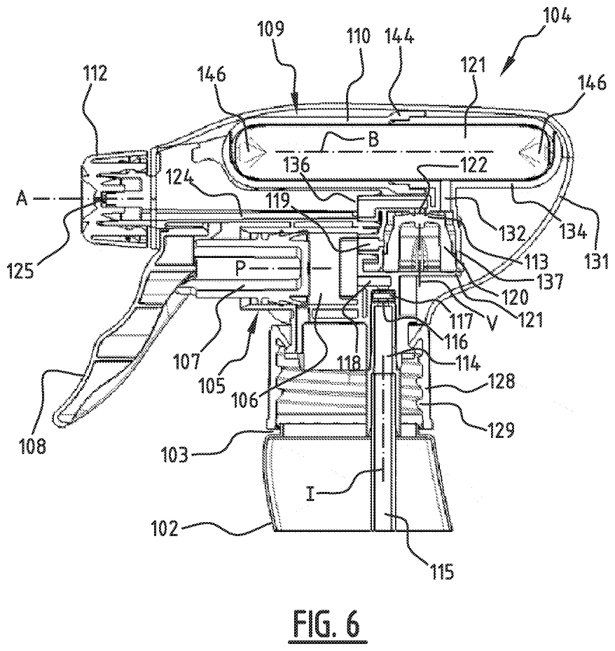

FIG. 6 is an enlarged scale cross-sectional view along the lines VI-VI in FIG. 5;

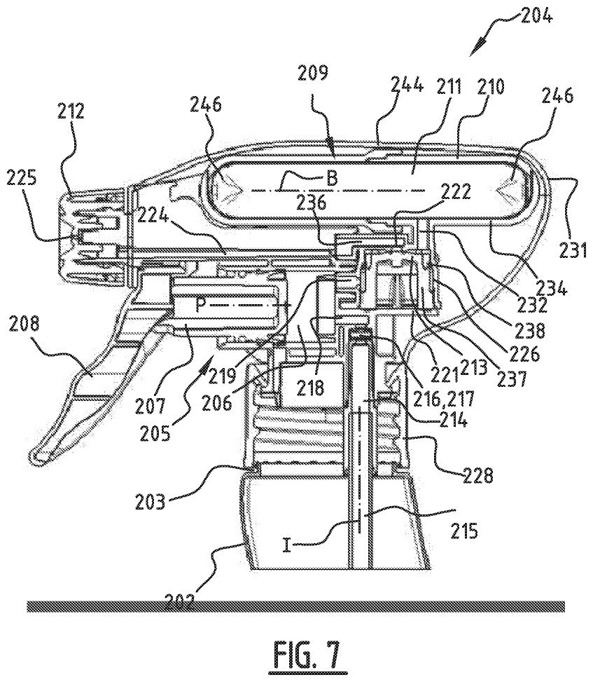

FIG. 7 is a view corresponding with FIG. 6 showing a third embodiment of the liquid dispensing device;

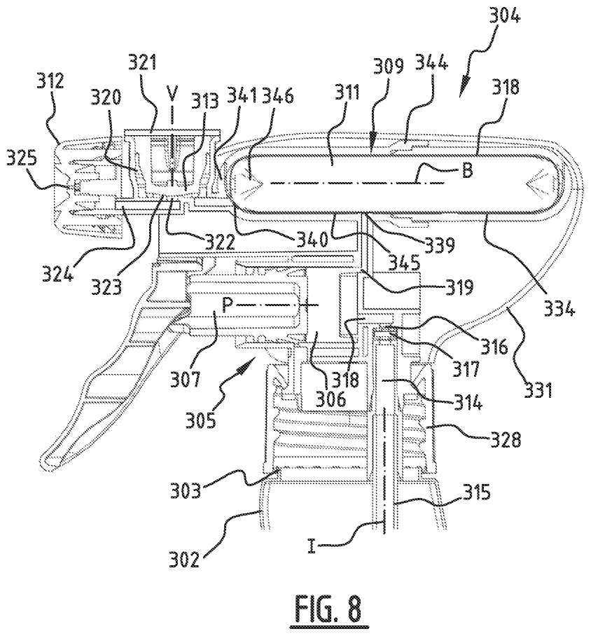

FIG. 8 is a view corresponding with FIGS. 6 and 7, showing the main parts of a fourth embodiment of the liquid dispensing device;

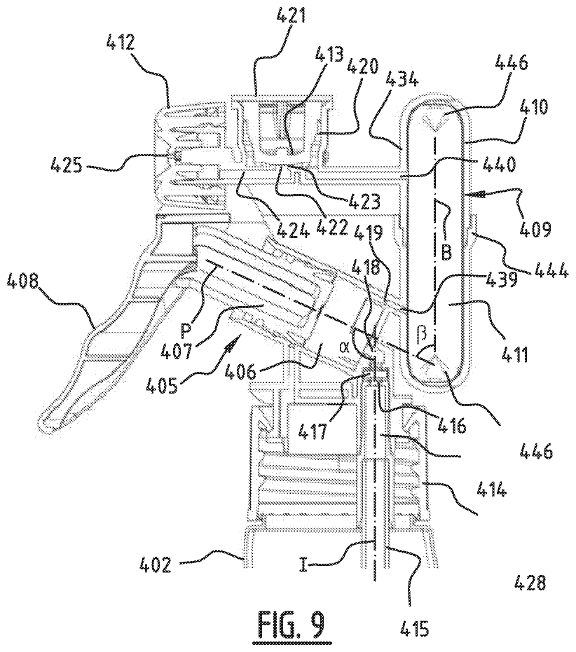

FIG. 9 is a view corresponding with FIGS. 6-8, showing the main parts of a fifth embodiment of the liquid dispensing device;

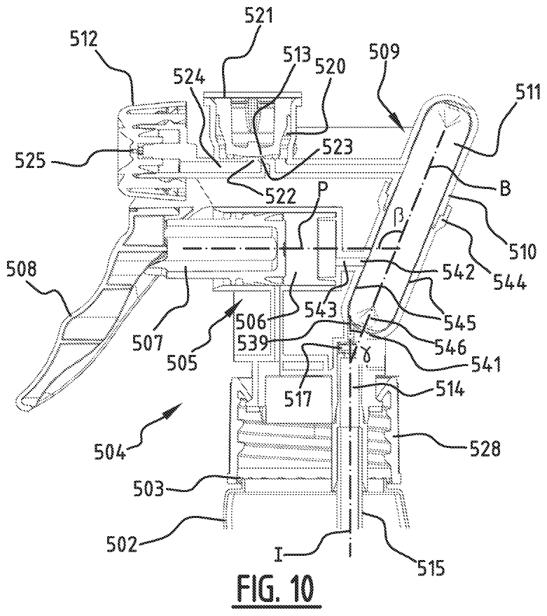

FIG. 10 is a view corresponding with FIGS. 6-9, showing the main parts of a sixth embodiment of the liquid dispensing device;

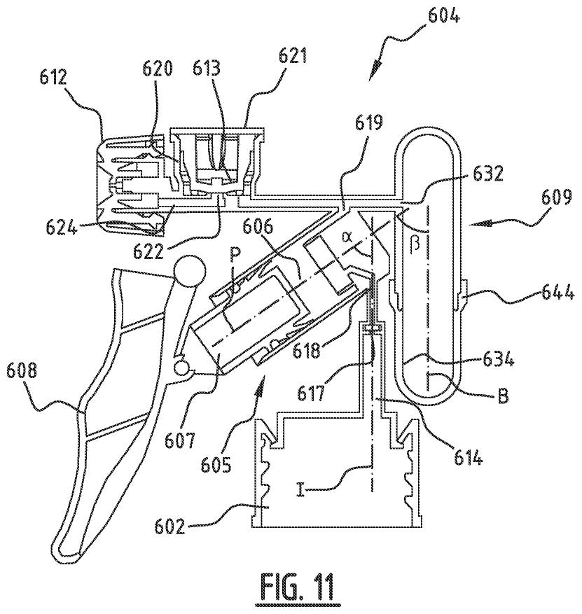

FIG. 11 is a schematic view corresponding with FIGS. 6-10, showing the main parts of a seventh embodiment of the liquid dispensing device;

FIG. 12 is a side view of an eighth embodiment of the liquid dispensing device;

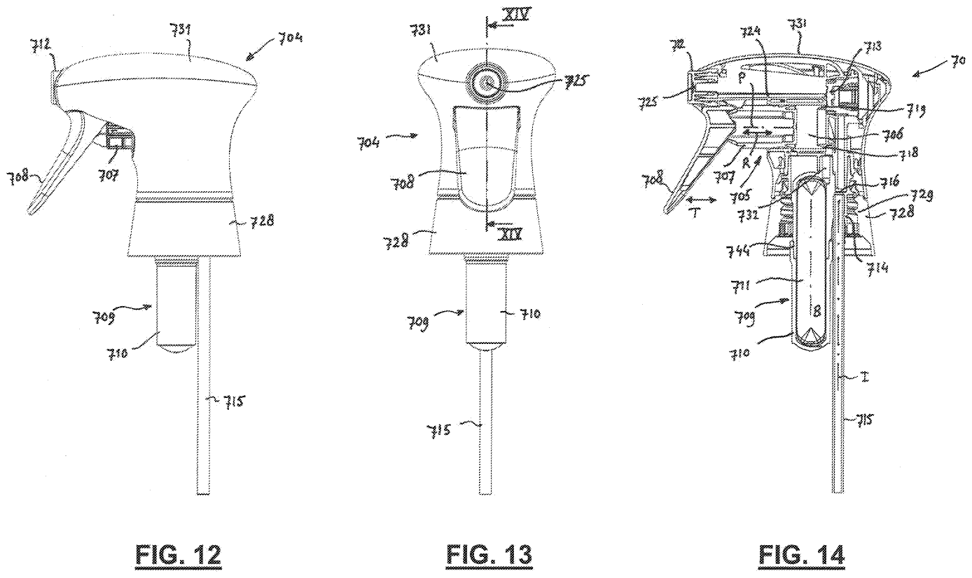

FIG. 13 is a front view of the liquid dispensing device of FIG. 12; and

FIG. 14 is a cross-sectional view along the lines XIV-XIV in FIG. 13.

A system 1 for dispensing a liquid comprises a container 2 which is at least partially filled with the liquid to be dispensed and which has a neck 3 (FIG. 3). The system 1 further comprises a liquid dispensing device 4 connected to the container neck 3.

The liquid dispensing device 4 comprises a pump 5 which includes a pump chamber 6 and a piston 7 that is reciprocally movable in the pump chamber 6 as indicated by arrow R. The device 4 further comprises a movable actuator 8, in the illustrated embodiment a trigger, which is operatively coupled to the piston 7. The actuator 8 may be pivotable or slidable as indicated by arrow T. It may be moved inward (to the right in the drawing) by a user exerting force to initiate a pump stroke, and may be moved outward by e.g. a return spring (not shown).

The liquid dispensing device 4 further comprises a gas buffer 9 which includes a buffer chamber 10 and a gas-filled compressible buffer bag 11 arranged in the buffer chamber 10. In the illustrated embodiment the buffer chamber 10 is substantially cylindrical and the buffer bag 9 is tubular and has ends 46 welded shut. The gas buffer 9 is in fluid communication with the pump 5.

The liquid dispensing device 4 also comprises a nozzle 12 for dispensing the liquid. In the illustrated embodiment the nozzle 12 is in fluid communication with the pump 5 and also with the gas buffer 9. The fluid communication between the nozzle 12 and the gas buffer 9 runs through the pump 5. In the illustrated embodiment, a fluid connection between the pump 5 and the gas buffer 9 includes an opening 32 that is arranged in a part of the buffer chamber 10 facing the pump 5.

A pre-compression valve 13 is arranged between the pump 5 and gas buffer 9 on the one hand and the nozzle 12 on the other. In the illustrated embodiment the pre-compression valve 13 is a dome valve which is arranged in a valve chamber 20 and locked therein by an end wall 21. The valve chamber 20 is shown to be offset from but parallel to the pump chamber 6.

And finally, the liquid dispensing device 4 comprises an inlet channel 14 which is configured to be brought in fluid communication with the container 2. In the illustrated embodiment the inlet channel 14 is arranged alongside the buffer chamber 10. The inlet channel 14 is configured to receive a top end of a dip tube 15 which extends into the container 2. The inlet channel 14 leads to an inlet opening 16 which may be closed by an inlet valve 17 sealingly abutting a valve seat 33.

In the illustrated embodiment, a pump inlet channel 18 connects the inlet opening 16 to the pump chamber 6, while a pump outlet opening 19 connects the pump chamber 6 to the valve chamber 20. An outlet opening 22 surrounded by a valve seat 23 is shown to connect the valve chamber 20 to an outlet channel 24 leading to the nozzle 12. In this embodiment, the pre-compression valve 13 normally abuts the valve seat 23 to interrupt the fluid communication between the pump 5 and gas buffer 9 and the nozzle 12.

The nozzle 12 includes a dispensing orifice 25 and may be rotatable around an axis A between various positions defining different operating states, like e.g. open and closed, spraying and foaming, or wide and narrow spray angles. These operating states may be indicated by different legends 26, 27 on different sides of the nozzle 12.

The liquid dispensing device 4 may further include a connector 28 for connecting the device 4 to the container 2. In this embodiment, the connector 28 comprises a ring having inner threading 29 which cooperates with outer threading 30 on the container neck 3.

In the illustrated embodiment, the various parts of the liquid dispensing device 4 are covered by a shroud 31 extending between the annular connector 28 and the nozzle 12.

In accordance with an aspect of the invention, the pump chamber 6 has an axis P defining the direction R of the reciprocal movement of the piston 7 which is arranged at an angle a with respect to an axis I of the inlet channel 14. In the illustrated embodiment, the axis P of the pump chamber 6 is substantially perpendicular to the axis I of the inlet channel 14. In other words, during normal use of the liquid dispensing system 1, when the container 2 and the inlet channel 14 will be substantially vertically oriented, the pump chamber 6 will be substantially horizontal.

As stated above, in this embodiment the inlet channel 14 is arranged alongside the buffer chamber 10. Consequently, in this arrangement an axis B of the gas buffer 9, which is substantially parallel to the axis I of the inlet channel 14, is substantially perpendicular to the axis P of the pump chamber 6. During normal use of the liquid dispensing system 1, the gas buffer 9 will be substantially vertically oriented. Arranging the gas buffer 9 alongside the inlet channel 14 allows it to extend through the neck 3 into the container 2. In this way the gas buffer 9 can be at least partially accommodated in the head space 35 of the container 2, resulting in a liquid dispensing system 1 which can be relatively compact.

During use of the liquid dispensing system 1, the pump 5 will first be primed by operating the trigger 8 one or more times. After priming, whenever the piston 7 is moved outward by the return spring after a pump stroke, liquid will be drawn from the container 2 through the dip tube 15, the inlet channel 14, the inlet opening 16 and the pump inlet channel 18 into the pump chamber 6. During such a return stroke or suction stroke, the inlet valve 17 will be lifted from its valve seat 33 as a result of the suction applied by the piston 7 moving outward.

During a subsequent pump stroke, as the piston 7 is moved inward by the trigger 8, the inlet valve 17 will be closed by the pressure created by the piston 7 moving inward, and the liquid in the pump chamber 6 will be forced through the pump outlet opening 19 into the valve chamber 20. There the liquid pressure will act on the dome-shaped part of the pre-compression valve 13. When the pressure of the liquid in the pump chamber 6 exceeds a cracking pressure of the pre-compression valve 13, the pre-compression valve 13 will be lifted from its valve seat 23, allowing the liquid to flow through the outlet opening 22 and the outlet channel 24 towards the nozzle 12 to be dispensed through the orifice 25.

The dimensions of the various parts of the liquid dispensing device 4 are such that the orifice 25 cannot dispense the liquid at the same rate as it is pressurized and forced past the pre-compression valve 13 by actuation of the pump 5. Pressurized liquid that cannot be dispensed through the orifice 25 flows through the pump inlet channel 18 and the opening 32 into the buffer chamber 10 where it compresses the gas-filled buffer bag 11. In order to allow the pressurized liquid to reach the cylindrical part of the buffer bag 11, which is more easily compressible than the rounded top, the buffer chamber 10 includes grooves or channels 45 in its sidewall 34.

If the piston 7, after having reached the inner end of its stroke, is held in that position by a user continuing to exert force on the trigger 108, the pressurized liquid that has accumulated in the buffer chamber 10 is forced out by expansion of the gas-filled buffer bag 11. As long as the pressure stored in the gas-filled buffer bag 111 exceeds the cracking pressure of the pre-compression valve 113, this liquid will be forced past the pre-compression valve 13 towards the nozzle 12, to be dispensed through the orifice 25. In this way liquid is dispensed from the nozzle 12 for a prolonged period.

After the last return stroke of the piston 7, i.e. when the user stops actuating the pump 5, the liquid flow will be interrupted, since the remaining liquid in the device 4 will be distributed over the volume of the pump chamber 6 and the gas buffer 9 and its pressure will fall below the cracking pressure of the pre-compression valve 13. The abrupt closure of the pre-compression valve 13 will prevent any dripping.

In another embodiment of the liquid dispensing system 101 (FIGS. 4-6), a somewhat different container 102 is combined with a second embodiment of the liquid dispensing device 104.

In this embodiment, the axis B of the gas buffer 109 is arranged substantially parallel to the axis P of the pump chamber 106, which again is substantially perpendicular to the axis I of the inlet channel 114. The valve chamber 120 is shown to be arranged between the pump 105 and the gas buffer 109. In the illustrated embodiment, an axis V of the valve chamber 120 is substantially perpendicular to the axis P of the pump chamber 6, so that the pre-compression valve 113 is movable in vertical direction towards or away from its valve seat 123.

The pump outlet opening 119 is connected to a sidewall of the valve chamber 120, while the gas buffer 109 is connected to the valve chamber 120 by the opening 132, which is arranged parallel to the outlet opening 122. This opening 132 is formed in the sidewall 134 of the buffer chamber 110, which faces the pump 105. A bend 136 connects the outlet opening 122 to the outlet channel 124, which is shown to be substantially parallel to both the pump chamber 106 and the buffer chamber 110.

Also in this embodiment, during a return stroke or suction stroke of the piston 107 liquid will be drawn from the container 102 through the dip tube 115 and the inlet channel 114, and past the open inlet valve 117 through the inlet opening 116 and the pump inlet channel 118 into the pump chamber 106.

During a subsequent pump stroke the inlet valve 117 will be closed and the liquid in the pump chamber 106 will be forced through the pump outlet opening 119 into the valve chamber 120. There the liquid pressure will flow around a sleeve 137 and act on the dome-shaped part of the pre-compression valve 113 to force the dome-shaped part from its valve seat 123. Excess liquid which cannot be dispensed through the orifice 125 will flow through the valve chamber 120 and the opening 132 into the buffer chamber 110 where it compresses the gas-filled buffer bag 111 to maintain the pressure within the device 104.

Accumulated liquid will be released from the buffer chamber 110 if the piston 107 is held at the end of the pump stroke. This liquid will flow past the pre-compression valve 113 to prolong the dispensing phase. When the trigger 108 is released and the piston 107 performs a return stroke, the remaining liquid will flow from the buffer chamber 110 back through the valve chamber 120 and into the pump chamber 106 This will immediately lower the liquid pressure in the device 104 below the cracking pressure of the pre-compression valve 113, which then closes to interrupt dispensing.

Arranging the gas buffer 109 in the liquid dispensing device 104 proper simplifies the manufacturing process of the liquid dispensing system 101. When assembling the liquid dispensing device 104 and the container 102 at the end of a liquid filling line, only the dip tube 115 has to be inserted into the neck 103 of the container 102. There is more clearance around the dip tube 115 than around a combination of dip tube and buffer chamber as shown in FIG. 3, which allows a greater freedom of movement and reduces the risk of inadvertent contact between the various parts during assembly.

In a third embodiment of the liquid dispensing device 204, a non-return valve 238 is arranged between the gas buffer 209 and the pump 205 (FIG. 7). This is the only difference between the second and third embodiments. In the illustrated embodiment the non-return valve 238 is formed by an extension of the sleeve 237 of the dome valve 213, which sealingly abuts the sidewall of the valve chamber 220.

During a pump stroke of the piston 207 the third embodiment functions in exactly the same way as the second embodiment. During such pump stroke, pressurized liquid is forced into the valve chamber 220 and past the non-return valve 238. Part of the pressurized liquid flows past the opened pre-compression valve 213 to the orifice 225, while excess liquid flows into the buffer chamber 210.

During a return stroke of the piston 207 the third embodiment functions differently from the second embodiment. During such return stroke, the non-return valve 238 will close and the liquid accumulated in the gas buffer 209 will flow past the opened pre-compression valve 213 to the orifice 225. This resembles the function of the second embodiment when the trigger is held at the end of the pump stroke.

If the pump 205 is actuated at a sufficiently high frequency, pressure build-up in the gas buffer 209 may be such that a continuous flow of liquid towards the orifice 225 is generated, which allows this embodiment of the liquid dispensing device 204 to act like an aerosol.

In a fourth embodiment of the liquid dispensing device 304 (FIG. 8), the gas buffer 309 is once again arranged in the device proper, leaving only the dip tube 315 to be inserted into the container neck 303. In this embodiment the axes B and P of the gas buffer 309 and the pump 305 are again arranged substantially parallel to each other and perpendicular to the axis I of the inlet channel 314.

The valve chamber 320 is shown to be arranged between the gas buffer 309 and the nozzle 312 and again to have its axis V substantially perpendicular to the axis P of the pump chamber 306. In this embodiment the buffer chamber 310 includes an inlet opening 339 connected to the pump outlet opening 319 and an outlet opening 340 connected to the valve chamber 320. The inlet opening 339 is shown to be arranged in the sidewall 334 of the buffer chamber 310, while the outlet opening 340 is arranged in an end wall 341.

In this embodiment the pump 305 and the gas buffer 309 are arranged in series. During a return stroke or suction stroke of the piston 307 this embodiment of the device 304 acts in the same way as the other embodiments. Liquid will be drawn from the container 302 through the dip tube 315 and the inlet channel 314, and past the open inlet valve 317 through the inlet opening 316 and the pump inlet channel 318 into the pump chamber 306.

During a pump stroke of the piston 307 the pressurized liquid will be forced through the pump outlet opening 319 into the inlet opening 339 of the buffer chamber 310. The liquid will then flow past the buffer bag 311 to the outlet opening 340, and will enter the valve chamber 320. When the liquid pressure exceeds the cracking pressure, the dome-shaped part of the pre-compression valve 313 will be lifted from its valve seat 323 and the liquid will flow through the outlet opening 322 and the outlet channel 324 towards the orifice 325 of the nozzle 312.

Excess liquid, which cannot be dispensed at the rate of pumping, will remain in the buffer chamber 310, compressing the gas-filled buffer bag 311. The liquid accumulated in the buffer chamber 310 will be dispensed if the trigger 308 is held at the end of the pump stroke of the piston 307. As soon as the trigger 308 is released, the piston 307 will be returned and liquid will flow from the gas buffer 309 towards the pump chamber 306, lowering the liquid pressure below the cracking pressure of the pre-compression valve, so that dispensing will be interrupted.

In a fifth embodiment of the liquid dispensing device 404 (FIG. 9), the pump 405 and the gas buffer 409 are once again arranged in series. However, in this embodiment the axis P of the pump chamber 406 is arranged at an obtuse angle a to the axis I of the inlet channel 414. The gas buffer 409 is arranged at a side of the pump chamber 406 opposite the actuator 408, and its axis B is arranged at an acute angle β with respect to the axis P of the pump chamber 406. In the illustrated embodiment the angles α, β are supplementary angles and the gas buffer 409 is substantially parallel to the inlet channel 414. The inlet opening 439 of the buffer chamber 410 is again arranged in its sidewall 434, but in this embodiment the outlet opening 440 is arranged in the sidewall 434 as well.

This arrangement of the pump 405 and gas buffer 409 leads to a somewhat more compact dispensing device 404 than the previous embodiments. Nevertheless, this fifth embodiment functions in the same way as the fourth embodiment. During a return stroke or suction stroke, liquid will be drawn from the container 402 into the pump chamber 406 through dip tube 415, inlet channel 414, inlet opening 416 and pump inlet channel 418. During a pump stroke, pressurized liquid will be forced through pump outlet opening 419 into buffer inlet opening 439, past buffer bag 411 to outlet opening 440 and into valve chamber 420.

In a sixth embodiment of the liquid dispensing device 504 (FIG. 10), a part of the gas buffer 509 may be arranged between the inlet channel 514 and the pump 505. In this embodiment the axis P of the pump chamber 506 is substantially perpendicular to the axis I of the inlet channel 514, while the axis B of the gas buffer 509 is at an obtuse angle β with respect to the axis P of the pump chamber 506 and at an acute angle γ to the axis I of the inlet channel 514. The inlet channel 514 is connected to an inlet opening 539 in an end wall 541 of the buffer chamber 510, while an intermediate opening 542 in the sidewall 534 of the buffer chamber 510 leads to a common pump inlet and outlet opening 543. An outlet opening 540 in the sidewall 534 of the buffer chamber 510 leads to the valve chamber 520 and the nozzle 512.

During a return or suction stroke of the piston 507 liquid is again drawn through the inlet opening 516 past the inlet valve 517. This liquid then enters the buffer chamber 510 through the inlet opening 539 and flows past the gas-filled buffer bag 511 through the grooves 545 arranged in the sidewall 534. The liquid is drawn from the buffer chamber 510 into the pump chamber 506 through the intermediate opening 542 and the pump inlet/outlet opening 543.

During a pump stroke of the piston 507 the liquid is forced from the pump chamber 506 through the pump inlet/outlet opening 543 and the intermediate opening 542 into the buffer chamber 510. The pressurized liquid compresses the gas-filled buffer bag 511 and flows towards the buffer outlet opening 540. Part of the pressurized liquid will flow to the valve chamber 520, past the pre-compression valve 513 and towards the nozzle 512 to be dispensed through the orifice 525, while excess liquid will remain in the buffer chamber 510 to be dispensed if the trigger 508 is held at the end of the pump stroke. When the user releases the trigger 508 and allows the piston 507 to perform its return stroke, liquid will immediately flow back from the gas buffer 509 into the pump chamber 506 so that dispensing will be interrupted instantly.

In a seventh embodiment of the liquid dispensing device 604 (FIG. 11), the gas buffer 609 and the inlet channel 614 are arranged in parallel, like in the first embodiment.

Here, the axis P of the pump chamber 606 is arranged at an acute angle a to the axis I of the inlet channel 614. The gas buffer 609 is again arranged at the side of the pump chamber 606 opposite the actuator 608, and its axis B is arranged at an acute angle β to the pump chamber axis P as well. The angles α, β are substantially identical and the gas buffer 609 is substantially parallel to the inlet channel 614.

The opening 632 connecting the buffer chamber 610 to the pump chamber 606 and to the nozzle 612 is arranged in the sidewall 634 facing the pump 605. The arrangement of the pre-compression valve 613, the outlet channel 624 and the nozzle 612 in this embodiment is the same as in the fourth, fifth and sixth embodiments.

During a return or suction stroke of the piston 607 liquid is again drawn through the inlet channel 614, past the inlet valve 617, through the pump inlet opening 618 into the pump chamber 606. During a subsequent pump stroke the inlet valve 617 will be closed and the liquid will be forced from the pump chamber 606 through the pump outlet opening 619 into the valve chamber 620. Excess liquid which cannot be dispensed through the orifice of the nozzle 612 will flow through the opening 632 into the buffer chamber 610 where it will compress the gas-filled buffer bag 611 to maintain the pressure within the device 604 and allow prolonged dispensing while the piston 607 is held at the end of its pump stroke. Here again, once the user releases the trigger 608, the liquid will flow back from the gas buffer 609 into the pump chamber 606 and dispensing will be stopped.

In an eighth embodiment of the liquid dispensing device 704 (FIGS. 12-14), the gas buffer 709 and the inlet channel 714 are arranged in parallel, like in the first embodiment. Also like in the first embodiment, the axis P of the pump chamber 706 is substantially perpendicular to both the axis B of the buffer 709 and the axis I of the inlet channel 714. This eighth embodiment differs from the first embodiment mainly in its shape and dimensions, but functions substantially in the same manner. A difference is that the nozzle 712 is not movable between various positions which define different operating states, but is fixed.

Here again, during a return or suction stroke of the piston 707 liquid is drawn through the inlet channel 714, past the inlet valve (not shown), through the pump inlet opening 718 into the pump chamber 706. During a subsequent pump stroke the inlet valve will be closed and the liquid will be forced from the pump chamber 706 through the pump outlet opening 719 past the valve 713 through the outlet channel 724 to the nozzle 712. Excess liquid which cannot be dispensed through the nozzle orifice 725 will flow through the opening 732 at the opposite end of the pump chamber 706 into the buffer chamber 710 where it will compress the gas-filled buffer bag 711 to maintain the pressure within the device 704 and allow prolonged dispensing while the piston 707 is held at the end of its pump stroke. Here again, once the user releases the trigger 708, the remaining liquid in the device 704 will be distributed over the volume of the pump chamber 706 and the gas buffer 709 and its pressure will fall below the cracking pressure of the pre-compression valve 713, so that dispensing will be stopped.

It should further be noted that in all illustrated embodiments the buffer housing is formed by two housing parts connected at a peripheral joint 44, 144, 244, 344, 444, 544, 644, 744.

The invention provides a relatively simple yet effective dispensing device which allows the pressure at which liquid is dispensed, and therefore the bandwidth of the liquid droplets, to be optimally controlled. Due to the presence of a buffer, dispensing may be prolonged when the piston is held at the end of a pump stroke. And when a non-return valve is arranged between the buffer and the pump, dispensing may even be substantially continuous as long as the pump is actuated. Since all parts of the dispensing device, including the buffer, are made of plastic materials, the device may be recycled after use, thus reducing the carbon footprint and the amount of waste material.

Although the invention has been described by reference to various exemplary embodiments, it is not limited thereto, and may be varied within the scope of the appended claims.

1. A device for dispensing a liquid from a container, comprising:
an inlet channel configured to be brought in fluid communication with the container;
a pump in fluid communication with the inlet channel, the pump including a pump chamber and a piston reciprocally movable in the pump chamber;
a gas buffer in fluid communication with the pump, the gas buffer comprising a buffer chamber and a gas-filled compressible buffer bag arranged in the buffer chamber;
a nozzle for dispensing the liquid, the nozzle in fluid communication with the pump and/or the gas buffer; and
a pre-compression valve arranged between the pump and/or gas buffer and the nozzle;
wherein the pump chamber has an axis defining a direction of reciprocal movement of the piston which is arranged at an angle with respect to an axis of the inlet channel.

2. The device as claimed in claim 1, wherein the axis of the pump chamber is substantially perpendicular to the axis of the inlet channel.

3. The device as claimed in claim 1, wherein the gas buffer has an axis which is arranged at an angle with respect to the axis of the pump chamber.

4. The device as claimed in claim 3, wherein the axis of the gas buffer is substantially perpendicular to the axis of the pump chamber.

5. The device as claimed in claim 3, wherein the gas buffer is configured to extend into a neck of the container.

6. The device as claimed in claim 3, wherein the axis of the gas buffer is arranged at an acute or obtuse angle with respect to the axis of the pump chamber.

7. The device as claimed in claim wherein an actuator is operatively coupled to the piston and wherein the gas buffer is arranged at a side of the pump chamber opposite the actuator.

8. The device as claimed in claim 1, wherein the gas buffer has an axis which is arranged substantially parallel to the axis of the pump chamber.

9. The device as claimed in claim 8, wherein the gas buffer extends along an outlet channel which constitutes the fluid communication between the nozzle and the pump and/or the gas buffer.

10. The device as claimed in claim claims, wherein the buffer chamber includes at least one opening for establishing the fluid communication with the pump and with the nozzle, the at least one opening being arranged in a part of the buffer chamber facing the pump.

11. The device as claimed in claim 1, wherein the buffer chamber includes an inlet opening for establishing the fluid communication with the pump and an outlet opening for establishing the fluid communication with the nozzle.

12. The device as claimed in claim 11, wherein the buffer chamber has a sidewall substantially surrounding the buffer bag and opposite end walls, and wherein at least one of the inlet opening and the outlet opening is arranged in the sidewall.

13. The device as claimed in claim 1, further comprising a pump outlet valve for interrupting the fluid communication between the gas buffer and the pump.

14. A system for dispensing a liquid, comprising a container and a liquid dispensing device as claimed in claim 1.
